(19) United States
(12) Patent Application Publication
(10) Pub. No.: US 2013/0324268 A1
(43) Pub. Date: Dec. 5, 2013

(54) CONSTANT VELOCITY JOINT FOR VEHICLE

(71) Applicants: HYUNDAI MOTOR COMPANY, Seoul (KR); KIA MOTORS CORPORATION, Seoul (KR); HYUNDAI WIA CORPORATION, Changwon-si (KR)

(72) Inventors: Won Jun Choi, Busan (KR); Yong Jin Kim, Gwangmyeong-si (KR); Hyangcheol Jo, Suwon-si (KR)

(73) Assignees: Hyundai Motor Company, Seoul (KR); Hyundai WIA Corporation, Changwon-si (KR); Kia Motors Corporation, Seoul (KR)

(21) Appl. No.: 13/712,833

(22) Filed: Dec. 12, 2012

(30) Foreign Application Priority Data
Jun. 4, 2012 (KR) 10-2012-0059998

(51) Int. Cl. F16D 3/24

(52) U.S. Cl. CPC F16D 3/24
USPC 464/152

(57) ABSTRACT

A constant velocity joint apparatus for a vehicle may include an outer race, an inner race disposed inside the outer race, and a cage that may be disposed between the inner race and the outer race and has a plurality of ball tracks that may be formed on an spherical inner side of the outer race and an spherical outer side of the inner race to retain balls disposed between the outer race and the inner race, wherein a first ball track-pressing angle applied to the balls from the ball tracks of the outer race and a second ball track-pressing angle applied to the balls from the ball tracks of the inner race may be set different.

### CROSS-REFERENCE TO RELATED APPLICATION

The present application claims priority to Korean Patent Application No. 10-2012-0059998 filed on Jun. 4, 2012, the entire contents of which is incorporated herein for all purposes by this reference.

### BACKGROUND OF THE INVENTION

1. Field of the Invention

The present invention relates to a constant velocity joint for a vehicle. More particularly, the present invention relates to a constant velocity joint for a vehicle which improves torque transmission efficiency by improving the ball track structure of an outer race and an inner race.

2. Description of Related Art

In general, a joint is a device for transmission rotational power (torque) to rotary shafts with different angles, and a hook joint and a flexible joint are used for the propellant shaft with a small power delivery angle, and a constant velocity joint is used for the driving shaft of vehicle which has a large power delivery angle.

The constant velocity joint generally includes an outer race with a plurality of curved ball tracks on the spherical inner side, an inner race with a plurality of curved ball tracks on the outer side of the sphere, radially opposite to the ball tracks, a plurality of balls retained in each of pair of opposite ball tracks and transmitting rotational power of the inner race to the outer race, and a cage supporting the balls.

The cage has a spherical inner side guided by the spherical inner side of the outer race and a spherical inner side guided by the spherical outer side of the inner race, and a plurality of pockets retaining the balls are circumferentially formed.

However, the constant velocity joint for a vehicle of the related art are generally used for both the front wheels and the rear wheels, and when it is applied to a front wheel of a vehicle, a large change in angle is required for steering, such that the twist angle of the constant velocity joint for a vehicle increases and torque is lost by friction force between the internal parts, thereby deteriorating torque transmission efficiency.

Further, the magnitude of the friction force is determined by the magnitude of the pressing angle of the balls being in contact with the ball tracks on the outer race and the inner race in the constant velocity joint, and accordingly, the larger the pressing angle, the more the efficiency can be increased, but the ball are pushed out of the ball tracks, so that the balls come out from the ball tracks on the outer race and the inner race at the maximum twist angle.

Therefore, it is necessary to increase the pressing angle in order to increase the efficiency of the constant velocity joint and to increase a PCD (Pitch Circle Diameter) of the constant velocity joint in order to ensure the margin of the ball tracks, so that the entire outer diameter and weight increase, which increases the manufacturing cost and deteriorates the package performance of a vehicle.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a constant velocity joint having advantages of improving torque transmission efficiency by improving the structures of an outer race and an inner race, and of reducing the manufacturing cost and improving the package performance of a vehicle by reducing the entire outer diameter and weight.

In an aspect of the present invention, a constant velocity joint apparatus for a vehicle may include an outer race, an inner race disposed inside the outer race, and a cage that is disposed between the inner race and the outer race and may have a plurality of ball tracks that are formed on an spherical inner side of the outer race and an spherical outer side of the inner race to retain balls disposed between the outer race and the inner race, wherein a first ball track-pressing angle applied to the balls from the ball tracks of the outer race and a second ball track-pressing angle applied to the balls from the ball tracks of the inner race are set different.

A spherical outer side of the cage is guided in contact with the spherical inner side of the outer race, and a spherical inner side of the cage is guided in contact with the spherical outer side of the inner race.

The first ball track-pressing angle of the outer race is set to be smaller than the ball track-pressing angle of the inner race.

The first ball track-pressing angle of the outer race is set within a range between 35° and 40°.

The second ball track-pressing angle of the inner race is set within a range between 40° and 45°.

An outer diameter of the outer race is decreased such that the first ball track-pressing angle of the outer race is decreased.

An arc length of the ball tracks disposed in the outer race is shorter than an arc length of the ball tracks disposed in the inner race.

Centers of the balls are disposed on the cage.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a front view of a constant velocity joint for a vehicle according to an exemplary embodiment of the present invention.

FIG. 2 is a diagram illustrating ball track-pressing angles of an outer race and an inner race in a constant velocity joint for a vehicle according to an exemplary embodiment of the present invention.

FIG. 3 is a table comparing values and efficiencies according to pressing angles of a constant velocity joint for a vehicle according to an exemplary embodiment of the present invention with those of the related art.

FIG. 4 is a graph comparing the relationship of efficiency of a joint angle of a constant velocity joint for a vehicle according to an exemplary embodiment of the present invention with those in the related art, in accordance with the difference in pressing angle of an outer race and an inner race.

FIG. 5 is a graph showing a reduction rate of torque transmission efficiency according to a joint angle of a constant velocity joint for a vehicle according to an exemplary embodiment of the present invention with those of the related art.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

The exemplary embodiments described herein and the configurations shown in the drawings are only examples of the present invention and do not fully include the scope of the present invention, therefore, it should be understood that there may be various equivalents and modifications that can replace those at the time of this application.

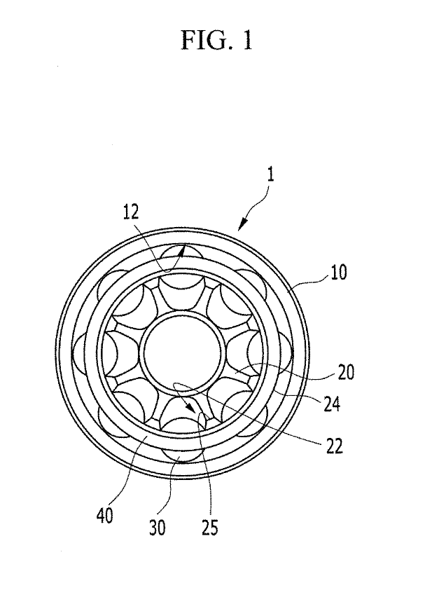

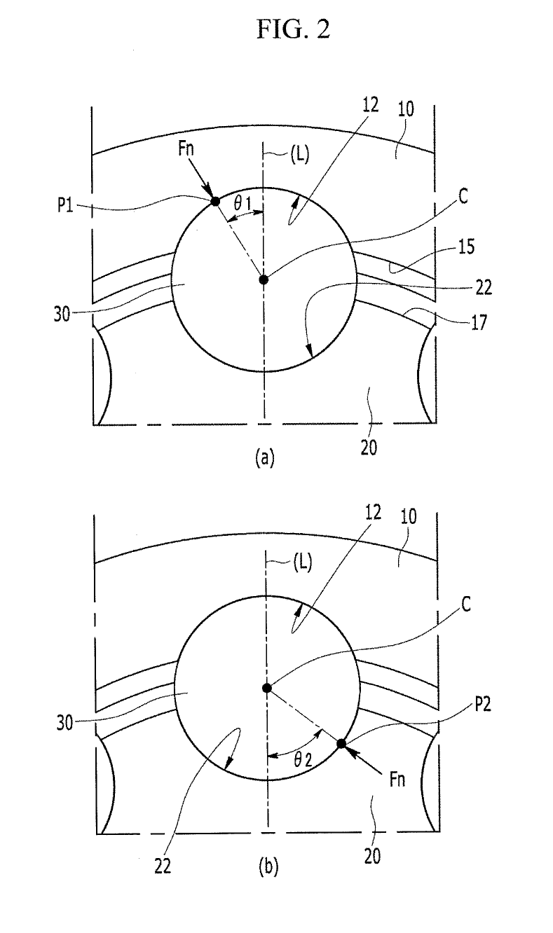

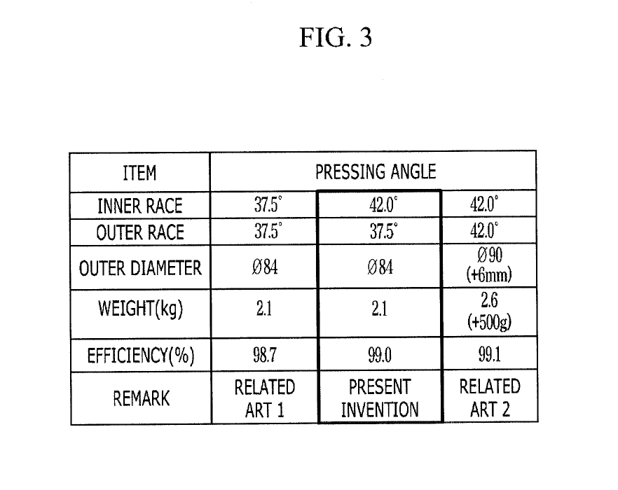

FIG. 1 is a front view of a constant velocity joint for a vehicle according to an exemplary embodiment of the present invention, FIG. 2 is a diagram illustrating ball track-pressing angles of an outer race and an inner race in a constant velocity joint for a vehicle according to an exemplary embodiment of the present invention, and FIG. 3 is a table comparing values and efficiencies according to pressing angles of a constant velocity joint for a vehicle according to an exemplary embodiment of the present invention with those of the related art.

Referring to the figures, a constant velocity joint 1 for a vehicle according to an exemplary embodiment of the present invention has a structure that can improve torque transmission efficiency by improving the structure of ball tracks 12 and 22 of an outer race 10 and an inner race 20, and can reduce the manufacturing cost and improve the package performance of a vehicle by reducing the entire outer diameter and weight.

For this structure, the constant velocity joint 1 for a vehicle according to an exemplary embodiment of the present invention basically includes the outer race 10 and the inner race 20, and also includes a cage 40 that has a plurality of ball tracks 12 and 22 that are formed on the spherical inner side 15 of the outer race 10 and the spherical outer side 17 of the inner race 20 to retain balls 30 disposed between the outer race 10 and the inner race 20. A spherical outer side 24 of the cage 40 is guided in contact with the spherical inner side 15 of the outer race 10 and a spherical inner side 25 of the cage 40 is guided in contact with the spherical outer side 17 of the inner race 20.

The constant velocity joint 1 for a vehicle according to an exemplary embodiment of the present invention has a ball track-pressing angle θ1 applied to the balls 30 from the ball track 12 of the outer race 10 and a pressing angle θ2 applied to the balls 30 from the ball track 22 of the inner race 20, where the ball-track pressing angles are set to be different.

The ball track-pressing angle θ1 of the outer race 10 is defined as the angle between the ball center C and a ball track-pressing point P1 of the outer race 10 which are in contact with the ball track 12 of the outer race 10 about an imaginary line L passing the ball center C of the ball 30 from the center of curvature of the outer race 10, as shown in (a) of FIG. 2.

Further, the ball track-pressing angle θ2 of the inner race 20, as shown in FIG. 3, is defined as the angle between the ball center C and a ball track-pressing point P2 of the inner race 20 which are in contact with the ball track 22 of the inner race 20 about the imaginary line L passing the ball center C of the ball 30 from the center of curvature of the outer race 10.

The ball track-pressing points P1 and P2 of the outer race 10 and the inner race 20 are points where the ball tracks 12 and 22 and the balls 30 are in contact and working load Fn is exerted.

The force that is applied to the ball tracks 12 and 22 depends on the ball track-pressing angels θ1 and θ2 of the outer race 10 and the inner race 20, which are defined as described above, so that when the pressing angels θ1 and θ2 are small, the force applied to the ball tracks 12 and 22 increases and the friction resistance of the balls 30 between the cage 40 and the outer race 10 and the inner race increases, thereby deteriorating torque transmission efficiency.

In contrast, when the ball track-pressing angels θ1 and θ2 of the outer race 10 and the inner race 20 are large, the force applied to the ball tracks 12 and 22 increases and the friction resistance of the balls 30 between the cage 40 and the outer race 10 and the inner race 20 reduces, so that the torque transmission efficiency increases, but the entire size and weight of the constant velocity joint increase.

Therefore, in the present exemplary embodiment, the ball track-pressing angle θ1 of the outer race 10 may be set to be smaller of the ball track-pressing angle θ2 of the inner race 20 (θ1<θ2) such that the torque transmission efficiency can be increased and the size and weight of the constant velocity joint 1 can be decreased.

The ball track-pressing angle θ1 of the outer race 10 may be set in the range of 35°˜40° and the ball track-pressing angle θ2 of the inner race 20 may be set within the range 40°˜45°.

Further, the outer race 10 may decrease in outer diameter such that the ball track-pressing angle θ1 of the outer race 10 reduces. Therefore, the PCD (Pitch Circle Diameter) of the constant velocity joint 1 decreases, so that the size and the weight decrease.

That is, in the constant velocity joint 1 according to an exemplary embodiment of the present invention, as shown in FIG. 3, the ball track-pressing angle θ2 of the inner race 20 is set to 42° and the ball track-pressing angle θ1 of the outer race 10 is set to 37.5° smaller than the ball track-pressing angle θ2 of the inner race 20.

Therefore, it can be seen that in the constant velocity joint 1 according to the present exemplary embodiment, the efficiency is improved as compared with the related art 1 and is substantially the same as that of the related art 2, but the outer diameter and weight are decreased.

In another aspect of the present invention, an arc length of the ball tracks disposed in the outer race 10 is shorter than an arc length of the ball tracks disposed in the inner race 20.

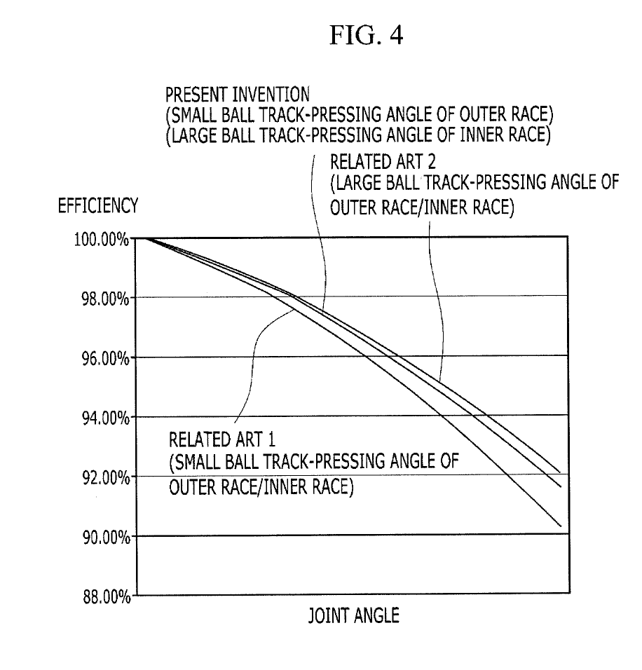

FIG. 4 is a graph comparing the relationship of efficiency of a joint angle of a constant velocity joint for a vehicle according to an exemplary embodiment of the present invention with those in the related art, in accordance with the difference in pressing angle of an outer race and an inner race.

Referring to FIG. 4, as the result of comparing the efficiency according to the magnitude of the joint angle of the constant velocity joint 1 according to the present exemplary embodiment with those of the related arts, on the basis of the values shown in the table of FIG. 4, it can be seen that the efficiency was improved, as compared with the related art 1 where the ball track-pressing angles θ1, θ2 of the outer race 10 and the inner race 20 were both set to be small.

In contrast, the efficiency of the constant velocity joint 1 has a little difference in efficiency, as compared with the related art 2 where the ball track-pressing angles θ1, θ2 of the outer race 10 and the inner race 20 were both set to be large, but it is possible to reduce the manufacturing cost and improve the package performance of a vehicle, by reducing the outer diameter and weight.

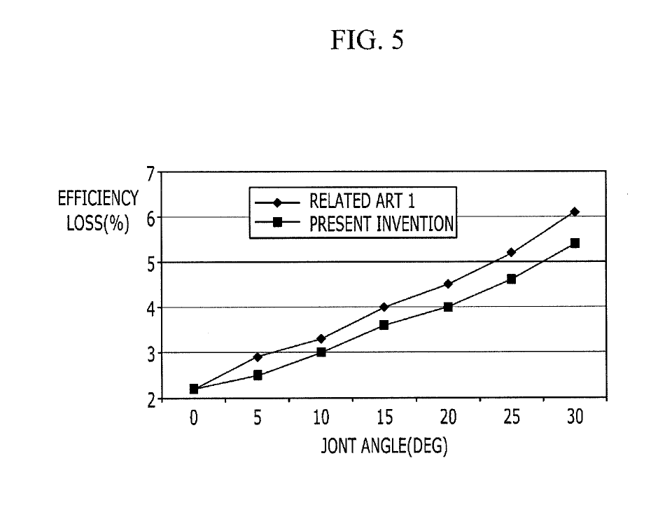

FIG. 5 is a graph showing a reduction rate of torque transmission efficiency according to a joint angle of a constant velocity joint for a vehicle according to an exemplary embodiment of the present invention with those of the related art.

Referring to FIG. 5, it can be seen that the reduction rate of the torque transmission efficiency is remarkably decreased in accordance with a change in magnitude of the joint angle in the constant velocity joint 1 for a vehicle according to an exemplary embodiment of the present invention, as compared with the related arts, by setting the ball track-pressing angle θ1 of the outer race 10 smaller than the ball track-pressing angle θ2 of the inner race 20.

On the other hand, when the constant velocity joint 1 for a vehicle according to an exemplary embodiment of the present invention is applied to a vehicle, the heat loss for the friction heat is reduced and the surface temperature of the outer race 10 is reduced, as compared with the related art, by improving the power delivery efficiency and reducing the friction between the internal parts.

Therefore, when the constant velocity joint 1 for a vehicle having the configuration according to an exemplary embodiment of the present invention is applied, it is possible to improve torque transmission efficiency by setting the ball track-pressing angle θ1 of the outer race 10 different from the ball track-pressing angle θ2 of the inner race 20.

Further, it is possible to prevent the balls from coming out from the ball tracks 12 and 22 of the outer race 10 and the inner race 20 at the maximum twist angle of the constant velocity joint 1 for a vehicle by reducing the entire outer diameter and weight, to reduce the manufacturing cost, and to improve the package performance of the vehicle.

Further, as the heat loss for the friction heat is reduced by reducing the friction amount the outer race 10, the inner race 20, the balls 30, and the cage 40, which are the parts in the constant velocity joint 1, it is possible to improve the commercial value of the product by increasing the entire durability.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A constant velocity joint apparatus for a vehicle comprising:
an outer race;
an inner race disposed inside the outer race; and
a cage that is disposed between the inner race and the outer race and has a plurality of ball tracks that are formed on an spherical inner side of the outer race and an spherical outer side of the inner race to retain balls disposed between the outer race and the inner race,
wherein a first ball track-pressing angle applied to the balls from the ball tracks of the outer race and a second ball track-pressing angle applied to the balls from the ball tracks of the inner race are set different.

2. The constant velocity joint apparatus of claim 1,
wherein a spherical outer side of the cage is guided in contact with the spherical inner side of the outer race, and
wherein a spherical inner side of the cage is guided in contact with the spherical outer side of the inner race.

3. The constant velocity joint apparatus of claim 1, wherein the first ball track-pressing angle of the outer race is set to be smaller than the ball track-pressing angle of the inner race.

4. The constant velocity joint apparatus of claim 1, wherein the first ball track-pressing angle of the outer race is set within a range between 35° and 40°.

5. The constant velocity joint apparatus of claim 1, wherein the second ball track-pressing angle of the inner race is set within a range between 40° and 45°.

6. The constant velocity joint apparatus of claim 1, wherein an outer diameter of the outer race is decreased such that the first ball track-pressing angle of the outer race is decreased.

7. The constant velocity joint apparatus of claim 1, wherein an arc length of the ball tracks disposed in the outer race is shorter than an arc length of the ball tracks disposed in the inner race.

8. The constant velocity joint apparatus of claim 1, wherein centers of the balls are disposed on the cage.
